(19) United States
(12) Patent Application Publication
(10) Pub. No.: US 2005/0143035 A1
(43) Pub. Date: Jun. 30, 2005

(54) Etching methods to prevent plasma damage to metal oxide semiconductor devices

(76) Inventor: Rae Sung Kim, Incheon (KR)

Correspondence Address: HANLEY, FLIGHT & ZIMMERMAN, LLC, 20 N. WACKER DRIVE, SUITE 4220, CHICAGO, IL, 60606, US

(21) Appl. No.: 11/025,010

(22) Filed: Dec. 28, 2004

(30) Foreign Application Priority Data
Dec. 31, 2003 (KR) 2003-0101339

(51) Int. Cl. H01Q 11/12

(52) U.S. Cl. 455/252.1

(57) ABSTRACT

Etching methods for preventing plasma damage to a metal oxide semiconductor (MOS) device include, while plasma etching an MOS device, setting the BF value to be within a range of about 0 to about 5, the RF power value and the phase value to be within ranges of about 480 to about 530 watts, and setting a phase value to be about 4 to about 60 respectively.

### TECHNICAL FIELD

The present disclosure relates to semiconductor fabrication and, more particularly, to etching methods to prevent plasma damage to metal oxide semiconductor (MOS) devices.

### BACKGROUND

As technology progresses, the trend is to fabricate a high quality MOS device having reduced gate oxide thickness. However, the non-uniformity created by the use of plasma techniques, which are used to reduce thickness of the gate oxide during an etching process, the makes quality of the thin film gate oxide poor.

Therefore, to produce semiconductor devices of better quality, it is required to find out, and put factors that affect to the plasma non-uniformity under control.

### BRIEF DESCRIPTION OF THE DRAWINGS

FIG. 1 illustrates a graph showing a result of a test while varying a Boron/Fluorine (BF) value, a radio frequency (RF) power value, and a phase value for a first antenna, antenna 1.

FIG. 2 illustrates a graph showing a result of a test while varying a BF value, a RF power value, and a phase value for a second antenna, antenna 2.

FIG. 3 illustrates a graph showing a result of second test for antenna 1.

FIG. 4 illustrates a graph showing a result of second test for antenna 2.

### DETAILED DESCRIPTION

To measure a quality of a gate oxide in an MOS device, in general three antenna patterns (antenna 1, antenna 2, and antenna 3), are used. It is very important to reduce a failure rate of the antenna pattern, because the drop of a thin film gate oxide quality causes an increase of failure rate of the antenna pattern, directly. Accordingly, antenna patterns are good indicators of thin film gate oxide quality of semiconductor devices.

As disclosed herein, the variables Boron/Fluorine (BF) value, Phase, and RF power are parameters that influence to a general process for etching an MOS device in a general etching chamber. Accordingly, appropriate control ranges for these three parameters are suggested.

In more detail, a split test was performed at the same etching apparatus, and at the same etching chamber by a Response Surface Method (RSM). The subject patterns of the test were “antenna 1,” “antenna 2,” and “antenna 3,” which are general antenna patterns used conventionally for measuring a quality of the gate oxide.

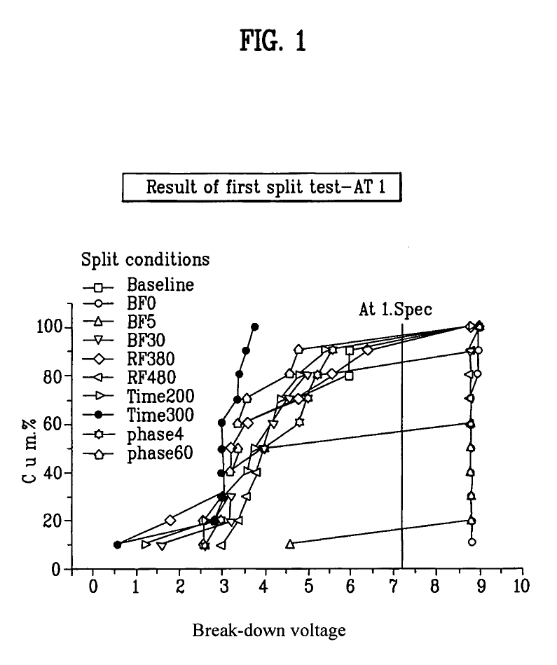

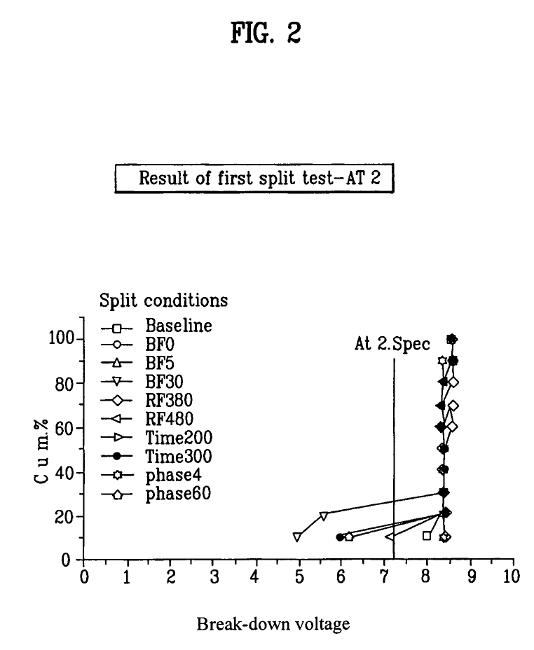

FIG. 1 illustrates a graph showing a result of a split test while varying a BF value, a RF power value, and a phase value for an antenna 1 (represented by ATI in the drawing), and FIG. 2 illustrates a graph showing a result of a split test while varying a BF value, a RF power value, and a phase value for an antenna 2 (represented by AT2 in the drawing).

In FIG. 1 or 2, the axis of ordinates represents Break-down Voltages, and the axis of abscissas represents C values. The “Baseline” in the graph of FIG. 1 or 2 represents a result of measurements for a reference sample that is tested under conditions with the BF value of 15, the RF power value of 430, a time period of 250, the phase of 36, and two cycles.

In the graph of FIG. 1 or 2, “BF0” represents one tested by setting the BF value of the reference sample to ‘0’ (i.e., BF₀) while setting the remaining conditions to be the same as the reference sample, and “BF5” and “BF30” represent tests performed by setting the BF value of the reference sample to ‘5’ and ‘30’ (i.e., BF₅ and BF₃₀) respectively, while setting the remaining conditions to be the same with the reference sample. Likewise, “RF380” and “RF480” represent ones tested by setting the RF power value to ‘380’ and ‘480,’ respectively, while setting the remaining conditions to be the same as the reference sample. “Time200” and “Time300” represent tests performed by setting the Time periods to ‘200’ and ‘300,’ respectively, while setting the rest of the conditions to be the same as the reference sample. “Phase4” and “Phase60” represent samples tested by setting the Phase values to ‘4’ and ‘60,’ respectively, while setting the remaining conditions to be the same as the reference sample.

The vertical line represented with “At1.Spec” in the graph of FIG. 1 represents a reference break-down voltage of the antenna 1. The vertical line represents the point at which there can be regarded that there is no problem in the quality. Similarly, the vertical line represented with “At2.Spec” in the graph of FIG. 2 represents a reference break-down voltage of the antenna 2, which represents a point at which there can be regarded that there is no problem in the quality.

As can be noted from FIGS. 1 and 2, though the reference sample with the BF value of 15 fails to pass the reference break-down voltage as the reference sample is broken-down before a test voltage reaches to the reference break-down voltage, both test samples with the BF values of 0 and 5 pass the reference break-down voltage. Eventually, it is known that, in etching the MOS device, it is required that BF values within a range of about 0 to about 5.

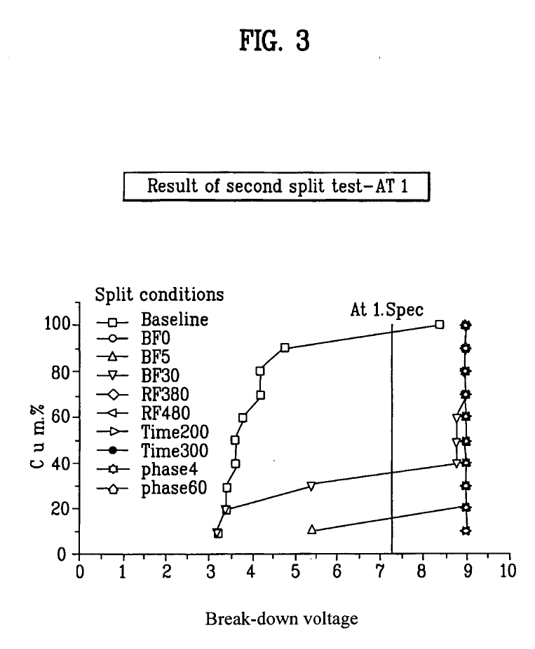

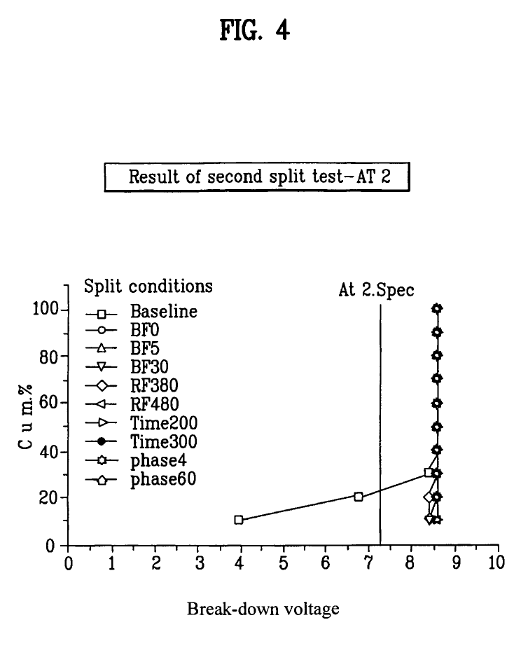

In the meantime, to fix ranges of the RF power value and the Phase value, second tests are performed, of which results are shown in FIGS. 3 and 4, respectively.

In detail, FIG. 3 illustrates a graph showing a result of a test while varying a the RF power value, and the phase value for the antenna 1 (represented with AT1 in the drawing), and FIG. 4 illustrates a graph showing a result of a test while varying the RF power value, and the phase value for the antenna 2 (represented with AT2 in the drawing).

In FIG. 1 or 2, the axis of ordinates represents Break-down Voltages, and the axis of abscissas represents C values. The “Baseline” in the graph of FIG. 1 or 2 represents a result of measurements for a reference sample which is tested, similar to the reference sample taken as a reference in the graph in FIG. 1 or 2, under conditions with the BF value of 15, the RF power value of 430, the time period of 250, and the phase of 36.

In the graph of FIG. 1 or 2, “B5” represents one tested by setting the BF value of the reference sample to ‘5’ while setting the remaining conditions to be the same as the reference sample, and “B5R480” and “B5R530” represent samples tested by setting the BF value to ‘5’ respectively and the RF power values to ‘480’ watts, and ‘530’ watts, respectively, of the reference sample while setting the remaining conditions to be the same with the reference sample. “B5R530P4” represents a sample tested by setting the BF value to 5, the RF power value to 530 watts, and the phase value to 4 for the reference sample while setting the remaining conditions to be the same with the reference sample. “B5R530P4C1” represents a sample tested by setting the BF value to 5, the RF power value to 530 watts, the phase value to 4, and a number of repetition to 1 for the reference sample while setting the remaining test conditions to be the same as the reference sample, and “B5R530P60C1” represents a sample tested by setting the BF value to 5, the RF power value to 530 watts, the phase value to 60, and a number of repetition to 1 for the reference sample while setting the remaining conditions to be the same as the reference sample.

The vertical line represented with “At1.Spec” in the graph of FIG. 3 represents a reference break-down voltage of the antenna 1, which can be regarded as the point at which there is no problem in the quality. Similarly, the vertical line represents “At2.Spec” in the graph of FIG. 4, which represents a reference break-down voltage of the antenna 2. This may also be considered the point at which there is no quality problem.

As can be noted from FIGS. 3 and 4, both test samples with the RF power values of 480 and 530 respectively pass the reference break-down voltage, and both test samples with the phase values of 4 and 60 respectively pass the reference break-down voltage. Eventually, in etching the MOS device, the RF power values within a range of about 480 to about 530 and the phase values within a range of about 4 to about 60 yield acceptable results.

According to this, in the MOS device etching, it is desirable that the BF value is within a range of about 0 to about 5, and the RF power value, and the phase value are set to be within ranges of about 480 to about 530 watts, and about 4 to about 60, respectively.

Described above is a process for etching an MOS device, which includes setting the BF value to be within a range of about 0 to about 5, the RF power value and the phase value to be within ranges of about 480 to about 530 watts, and about 4 to about 60 respectively, in a plasma etching, plasma damage that make a quality of a thin film gate oxide poor caused by plasma non-uniformity can be prevented.

Disclosed herein is an etching method for preventing plasma damage to a MOS device. The disclosed etching method prevents a drop in quality of a thin film gate oxide due to the plasma non-uniformity.

In one example, the disclosed method may include setting a BF value to be within a range of about 0 to about 5 when etching an oxide. Additionally, the method may include setting an RF power value to be within a range of about 480 to about 530 watts when etching the oxide. Further, the method may include setting a phase value to be within a range of about 4 to about 60 when etching the oxide.

This application claims the benefit of Korean Application No. P2003-0101339 filed on Dec. 31, 2003, which is hereby incorporated by reference as if fully set forth herein.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

1. A method of plasma etching a metal oxide semiconductor device comprising setting a BF value to be within a range of about 0 to about 5 while etching an oxide.

2. A method as defined in claim 1, further comprising setting an RF power value to be within a range of about 480 to about 530 watts while etching the oxide.

3. A method as defined in claim 2, further comprising setting a phase value to be within a range of about 4 to about 60 while etching the oxide.

4. A method as defined in claim 1, further comprising setting a phase value to be within a range of about 4 to about 60 while etching the oxide.
